(19) United States
(12) Patent Application Publication
(10) Pub. No.: US 2014/0211044 A1
(43) Pub. Date: Jul. 31, 2014

(54) METHOD AND SYSTEM FOR GENERATING IMAGE KNOWLEDGE CONTENTS BASED ON CROWDSOURCING

(71) Applicant: Electronics and Telecommunications Research Institute, Daejeon (KR)

(72) Inventors: Chung-ho LEE, Daejeon (KR); Joong-Ki PARK, Daejeon (KR); YOUNGHO SUH, Daejeon (KR); Youngsu CHO, Daejeon (KR); Sung Woong SHIN, Daejeon (KR); Jong-Hyun PARK, Daejeon (KR); Chae Kyu KIM, Daejeon (KR)

(73) Assignee: Electronics and Telecommunications Research Institute, Daejeon (KR)

(21) Appl. No.: 14/152,977

(22) Filed: Jan. 10, 2014

(30) Foreign Application Priority Data
Jan. 25, 2013 (KR) 10-2013-0008542
Oct. 8, 2013 (KR) 10-2013-0120012

(51) Int. Cl. H04N 5/232

(52) U.S. Cl. CPC H04N 5/23229
USPC 348/231.99

(57) ABSTRACT

A system for generating crowdsourcing-based image knowledge content, includes an image provision unit configured to provide image data; and an image crowdsourcing unit configured to generate, store, or manage image knowledge in order to provide an image-base knowledge service. Further, the system includes an image acquisition and processing unit configured to connect the image provision unit and the image crowdsourcing unit and actively or automatically provide a crowdsourcing technique.

### CROSS-REFERENCE TO RELATED APPLICATIONS

The present invention claims priority of Korean Patent Application No. 10-2013-0008542, filed on Jan. 25, 2013, and Korean Patent Application No. 10-2013-0120012, filed on Oct. 8, 2013, which are incorporated herein by references.

### FIELD OF THE INVENTION

The present invention relates to an image knowledge service platform, and more particularly, to a system and method for collecting, sharing, analyzing, linking, and intellectualize a variety of image contents, such as a black box image, a smartphone image, a CCTV image, a picture, etc., using the crowdsourcing technique to provide a knowledge service for establishment of national and social safety networks and promotion of social and culture activities.

### BACKGROUND OF THE INVENTION

“Knowledge service” is an abbreviation of “knowledge intensive business service (KIBS),” which is a knowledge-based service on the basis of human creativity, compared to a general labor-intensive service or a simple information providing service. In particular, the image knowledge service, which is a background of the present invention, is a service for generating and providing a knowledge content, which is meaningful information, from image data acquired through a variety of media.

Crowdsourcing is a compound of the words “crowd” and “outsourcing”, and may allow consumers or crowd to participate in entire business activities, thereby saving time and cost of troubleshooting and providing a wide range of troubleshooting. Successful representative examples of the crowdsourcing include Wikipedia, which is an online encyclopedia, and Open Street Map, which is an open source map. In addition, the crowdsourcing may also be a method of solving a specific problem through cooperation of a human intelligence and a computer cooperate. Recently, as the crowdsourcing is getting the spotlight, a variety of web-based crowdsourcing platforms have been developed. A representative example includes Mechanical Turk (MTurk) of Amazon (www.mturk.com). A user of MTurk decomposes a problem to be solved through the platform into small tasks, human intelligence tasks (HITs), which may be easily performed using human intelligence, and allows the crowd to participate in and perform respective tasks, thereby saving entire task cost to 10%. The crowdsourcing platform is utilized in a variety of fields. For example, Facewatch platform (www.facewatch.co.uk) utilizes the crowdsourcing to report and prevent crimes, and Tomnod platform (www.tomnod.com) utilizes the crowdsourcing to quickly analyze damage caused by a natural disaster, such as earthquake, flooding, etc.

Recently, a vast amount of image data is explosively increasing due to rapid spread of mobile devices, such as smartphone, tablet, etc., and diversification of image devices, such as a CCTV, a vehicle black box, etc. Thus, it is essential to provide a meaningful knowledge service in the excess of information and data. Accordingly, there is a need for a system and method for efficiently collecting, sharing, analyzing, linking, and intellectualizing data, using the crowdsourcing technique, to provide an image knowledge service.

However, there are several limitations in using the related art crowdsourcing platform.

First, the crowdsourcing platform can save time and cost and provide a wide range of troubleshooting through group intelligence when there are a lot of participants who are workers or producers. Thus, the related art platform technology passively depends on spontaneous searching and selection by a participant. That is, a participant should select his/her problem through direct search and then perform the problem. The platform cannot actively select and designate a worker or producer having capability for providing and analyzing image data suitable for specific time, space, or theme.

Second, a mobile crowdsourcing image device providing image data has a feature of alternating an online state and an offline stage, not maintaining the online state, due to problems such as personal privacy, security, communication cost, etc. Accordingly, a user of the image device intervenes and selects a portion of his/her data to provide the portion to a platform or participate in analysis of the portion, and thus intervention of an image data producer is great. This naturally allows the producer to hesitate and avoid participating therein, thereby reducing productivity of high-quality knowledge content.

### SUMMARY OF THE INVENTION

In view of the above, the present invention provides an active crowdsourcing-based image knowledge content generation system and method that can overcome limitation of passivity of a typical crowdsourcing platform and previously analyze ability of a producer.

That is, an image data producer participating in the crowdsourcing platform may generate metadata of an image apparatus of the producer and metadata of a position and a direction of the image apparatus at a time point of registering image data and perform a preprocessing process, such as indexing, geotagging, geocoding, translation, cropping, object/feature extraction, or compression, on the image data. Thus, the active crowdsourcing-based image knowledge content generation system and method may select a producer having the greatest ability of providing and analyzing image data suitable for a specific time/space/theme in view of the platform.

In addition, the present invention minimizes the intervention of a data producer, which is one of factors reducing high-quality knowledge content productivity to maximize the participation of the data producer. That is, the present invention can compose a personal profile of the producer and automatically provide image data with reference to the personal profile, thereby reducing the producer intervention.

The object of the present invention is not limited to the aforesaid, but other objects not described herein will be clearly understood by those skilled in the art from descriptions below.

In accordance with a first aspect of the present invention, there is provided A system for generating crowdsourcing-based image knowledge content. The system includes an image provision unit configured to provide image data; an image crowdsourcing unit configured to generate, store, or manage image knowledge in order to provide an image-base knowledge service; and an image acquisition and processing unit configured to connect the image provision unit and the image crowdsourcing unit and actively or automatically provide a crowdsourcing technique.

Further, the image acquisition and processing unit may comprise a human intelligence task (HIT) processing unit configured to process an HIT requested by the image crowdsourcing unit; and an image data preprocessing unit configured to search for the image data provided from the image provision unit to perform indexing, annotation, translation, cropping, object identification, feature extraction, or image compression on the image data.

Further, the image acquisition and processing unit may further comprise a producer profile database (DB) configured to store a profile of a producer of the image data; and a metadata database (DB) configured to store metadata of the image data.

Further, if a feature of the HIT requested by the image crowdsourcing unit is image data collection, the image data collection may be automatically performed using the profile of the producer, and if the feature of the requested HIT is image data analysis, the intervention of the producer may be requested.

Further, the image crowd sourcing unit may comprise an image-based knowledge generation unit configured to generate knowledge from the image data; and a real-time complex event management unit configured to monitor a meaningful complex event among a large amount of single events in real time to provide necessary information to an event listener interested in the event.

Further, the image crowdsourcing unit may further comprise an image knowledge DB configured to store or manages semantic 3-D image knowledge; an image knowledge ontology DB configured to provide an ontology for generating the semantic 3-D image knowledge; a semantic annotation generation unit configured to generate image information on the basis of the ontology provided from the image knowledge ontology DB; a moving object DBMS configured to store and manage a moving object generated by the image-based knowledge generation unit; and a multi-viewpoint image information DB configured to store and manage multi-viewpoint image information generated by the image-based knowledge generation unit.

Further, the image-based knowledge generation unit may comprise an image knowledge analysis and inquiry processing unit configured to provide an inquiry language and an inquiry engine for searching for and analyzing the semantic 3-D image knowledge on the basis of the viewpoints (object/feature/event) from the image knowledge DB; an image data processing unit configured to receive the image data and metadata from the image acquisition and processing unit, pre-process the image data through an image correction and image quality improvement filter, analyze the metadata to generate annotation of the image data, tag the image data with the annotation, and deliver the tagged image data; an image information processing unit configured to receive the image data tagged with the annotation from the image data processing unit, detect and classify objects using features of moving objects in the image data, and track and label the moving objects to extend the annotation; and an image knowledge processing unit configured to receive the image data tagged with the extensive annotation from the image information processing unit and generate the semantic 3-D image knowledge on the basis of the image information and the image knowledge ontology DB through the semantic annotation generation unit.

Further, the image crowdsourcing unit may further comprise a time space situation information management unit configured to provide an individual inquiry through the inquiry language provided by the image knowledge analysis and inquiry processing unit and when a complex situation is described and previously registered, monitor a situation, perceive the registered situation through inference, and provide necessary knowledge to a user.

In accordance with a second aspect of the present invention, there is provided a method of generating crowdsourcing-based image knowledge content executed in an image knowledge content generation system including an image provision unit, an image acquisition and processing unit, and an image crowdsourcing unit. The method includes registering the image provision unit with the image crowdsourcing unit; generating, by the image acquisition and processing unit, metadata of the image provision unit itself and image data provided by the image provision unit through search of the registered image provision unit and composing a profile of a producer; preprocessing the image data to transmit the preprocessed image data to the image crowdsourcing unit; and modeling, by the image crowdsourcing unit, the image data and generating relevant image knowledge.

Further, the method may further comprise receiving, by the image crowdsourcing unit, a service request; searching for and analyzing the image knowledge on the basis of the service request received from the image crowdsourcing unit; and requesting a human intelligence task (HIT) through crowdsourcing when the image knowledge stored and managed in the image crowdsourcing unit is not sufficient.

Further, the method may further comprise integrating, by image crowdsourcing unit, the HIT to generate a new knowledge content; and providing the generated knowledge content to a user.

Further, the preprocessing of the image data may comprise performing annotation, translation, cropping, object identification, feature extraction, or image compression on the image data.

Further, if a feature of the requested HIT is image data collection, the image data collection may be automatically performed using the profile of the producer, and if the feature of the requested HIT is image data analysis, the intervention of the producer may be requested.

Further, the method may further comprise storing or managing semantic 3-D image knowledge; providing an ontology for generating the semantic 3-D image knowledge; generating image information on the basis of the ontology; storing and managing a moving object generated by the image-based knowledge generation unit; and storing and managing multi-viewpoint image information generated by the image-based knowledge generation unit.

Further, the generating of knowledge from the image data may comprise providing an inquiry language and an inquiry engine for searching for and analyzing the semantic 3-D image knowledge on the basis of multi-viewpoints (object/feature/event); receiving the image data and metadata from the image acquisition and processing unit, pre-processing the image data through an image correction and image quality improvement filter, analyzing the metadata to generate annotation of the image data, tagging the image data with the annotation, and delivering the tagged image data; receiving the image data tagged with the annotation, detecting and classifying objects through features of moving objects in the moving object, and tracking and labeling the moving object to extend the annotation; and receiving the image data tagged with the extensive annotation and generating the semantic 3-D image knowledge.

The crowdsourcing-based image knowledge content generation system and method in accordance with an embodiment of the present invention generate a variety of knowledge and even provide a service associated with this knowledge, as well as collection, integration, and analysis of a large amount of image data, using the crowdsourcing technique. In particular, the present invention can solve problems of producer participation dependency and productivity reduction in a typical crowdsourcing platform, using an actively automated technique, thereby maximizing producer participation and providing a high-quality knowledge service.

In addition, the present invention can provide an image-based knowledge service platform and a customized knowledge content and thus lead knowledge service markets that can create high added values in a variety of fields, such as public safety, broadcasting communication, education, fire prevention, culture and the like.

### BRIEF DESCRIPTION OF THE DRAWINGS

The above and other objects and features of the present invention will become apparent from the following description of embodiments given in conjunction with the accompanying drawings, in which:

FIG. 1 is a block diagram showing an entire crowdsourcing-based image knowledge content generation system in accordance with an embodiment of the present invention;

FIG. 2 is a block diagram of an image acquisition and processing unit of the crowdsourcing-based image knowledge content generation system of FIG. 1;

FIG. 3 is a block diagram of an image crowdsourcing unit of the crowdsourcing-based image knowledge content generation system of FIG. 1;

FIG. 4 is a process flowchart of a crowdsourcing-based image knowledge content generation method in accordance with an embodiment of the present invention; and

FIGS. 5 to 8 are exemplary diagrams of a crowdsourcing-based image knowledge content generation system and method in accordance with an embodiment of the present invention.

### DETAILED DESCRIPTION OF THE EMBODIMENTS

Hereinafter, embodiment of the present invention will be described in detail with reference to the accompanying drawings which form a part hereof.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

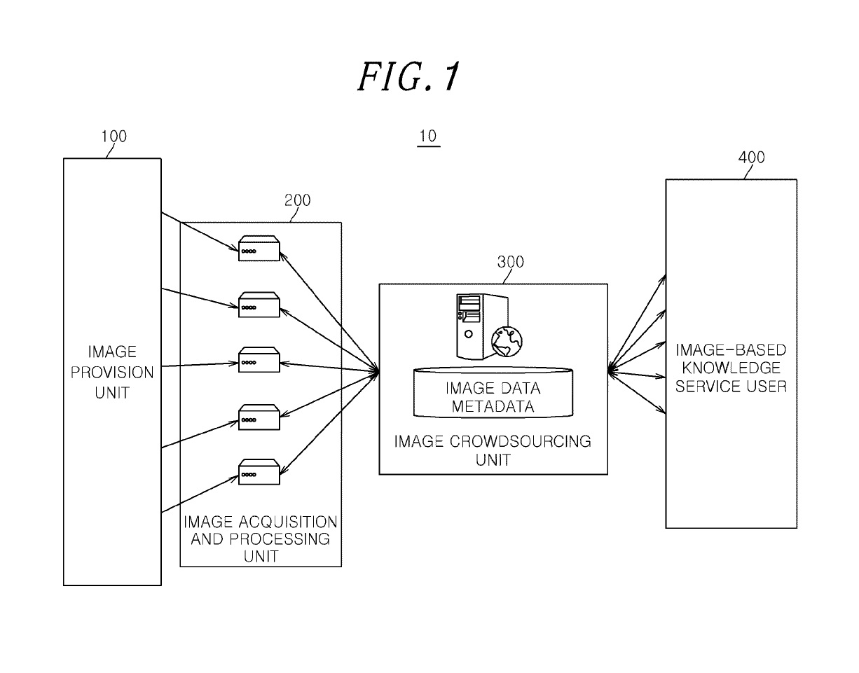

Hereinafter, an operation of each element of a crowdsourcing-based image knowledge content generation system in accordance with an embodiment of the present invention will be described below with reference to FIGS. 1 to 3.

FIG. 1 is a block diagram showing an entire crowdsourcing-based image knowledge content generation system 10 in accordance with an embodiment of the present invention, and may include an image provision unit 100, an image acquisition and processing unit 200, an image crowdsourcing unit 300, etc.

The image provision unit 100, such as a CCTV, a vehicle black box, an unmanned camera of an intra-city bus, a police car camera, smartphone, etc., provides image data, an image crowdsourcing unit 300 generates, stores, or manages image knowledge in order to provide an image-based knowledge service, and the image acquisition and processing unit connects the image crowdsourcing unit 300 with the image provision unit 100 to actively or passively provide the crowdsourcing technique.

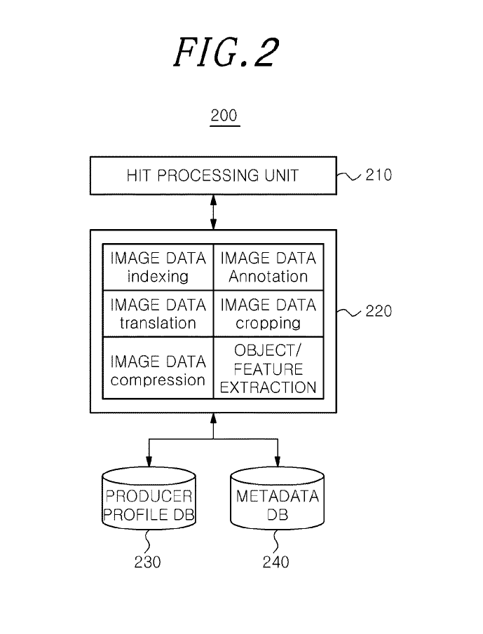

In addition, FIG. 2 is a block diagram of an image acquisition and processing unit of the crowdsourcing-based image knowledge content generation system of FIG. 1.

As shown in FIG. 2, the crowdsourcing-based image knowledge content generation system 10 in accordance with an embodiment of the present invention a human intelligence task (HIT) processing unit 210, an image data preprocessing unit 220, a producer profile database (DB) 230, and a metadata database (DB) 240, etc.

The HIT processing unit 210 processes a human intelligence task requested by the image crowdsourcing unit 300, and the image data preprocessing unit 220 searches for the image data provided from the image provision unit to perform indexing, annotation, translation, cropping, object identification, feature extraction, or image compression on the image data. In addition, the producer profile DB 230 stores a producer profile of the image data in order to minimize intervention of a producer of image data, and the metadata DB 240 stores metadata of the image data.

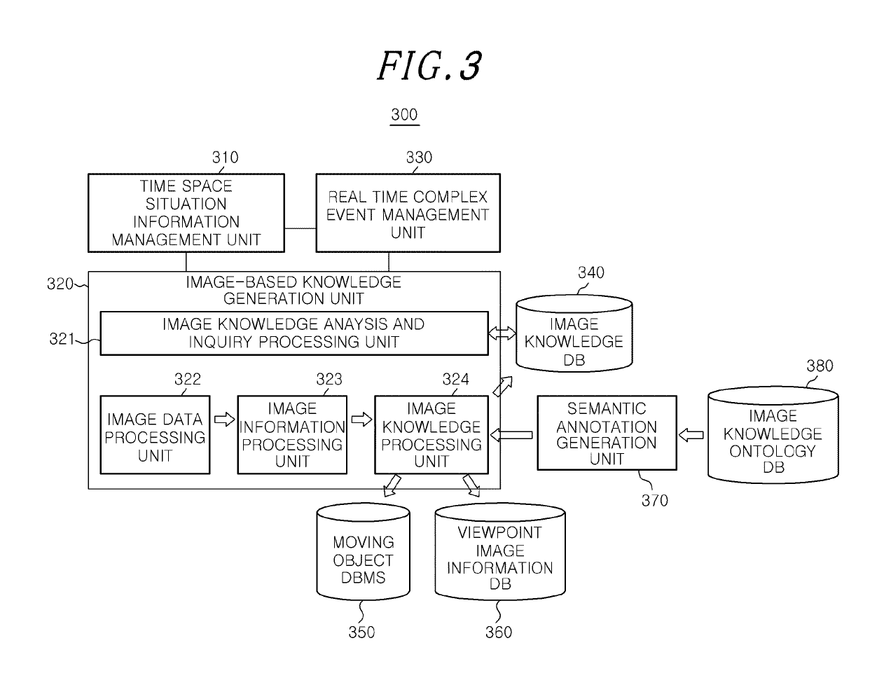

FIG. 3 is a block diagram of an image crowdsourcing unit of the crowdsourcing-based image knowledge content generation system of FIG. 1. The image crowdsourcing unit 300 may include a time space situation information management unit 310, an image-based knowledge generation unit 320, a real-time complex event management unit 330, an image knowledge DB 340, a moving object DBMS 350, a multi-viewpoint image information DB 360, a semantic annotation generation unit 370, an image knowledge ontology DB 380, etc. Here, the image-based knowledge generation unit 320 may include an image knowledge analysis and inquiry processing unit 321, image data processing unit 322, an image information processing unit 323, an image knowledge processing unit 324, etc.

The image-based knowledge generation unit 320 generates knowledge from the image data, and the real-time complex event management unit 330 monitors a meaningful complex event among a large mount of single events in real time to provide necessary information to a listener interested in the event.

The image knowledge DB 340 stores or manages semantic 3-D image knowledge, and the image knowledge ontology DB 380 provides an ontology for generating the manages semantic 3-D image knowledge, and the semantic annotation generation unit 370 the image information on the basis of the ontology provided from the image knowledge ontology DB.

In addition, the moving object DBMS 350 stores and manages a moving object generated through the image-based knowledge generation unit, and the multi-viewpoint image information DB 360 stores and manages multi-viewpoint image information generated through the image-based knowledge generation unit.

The image knowledge analysis and inquiry processing unit 321 provides an inquiry language and an inquiry engine for searching for and analyzing the semantic 3-D image knowledge on the basis of multi-viewpoints (object/feature/event) from the image knowledge DB, and the image data processing unit 322 receives the image data and metadata from the image acquisition and processing unit, pre-processes the image data with an image correction and image quality improvement filter, analyzes the metadata to generate annotation of the image data, and then tags the image data with the annotation and delivers the tagged image data.

The image information processing unit 323 receives the image data tagged with the annotation from the image data processing unit 323, detects and classifies moving objects in the image data using their features, and tracks and labels the moving objects to extend the annotation.

The image knowledge processing unit 324 receives the image data tagged with the extensive annotation from the image information processing unit and generates semantic 3-D image knowledge on the basis of the image information and image knowledge ontology DB 380 through the semantic annotation generation unit 370.

The time space situation management unit 310 provides an individual inquiry through the inquiry language provided by the image knowledge analysis and inquiry processing unit. In addition, when a complex situation is described and previously registered, the time space situation management unit 310 monitors a situation, perceives the registered situation through inference, and provides necessary knowledge to a user.

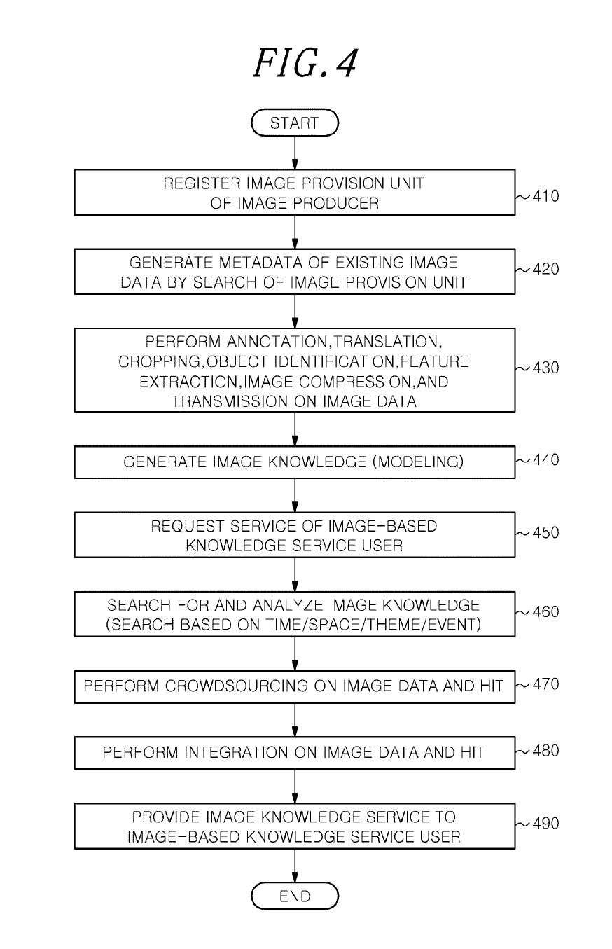

FIG. 4 is a process flowchart of a crowdsourcing-based image knowledge content generation method in accordance with an embodiment of the present invention.

The crowdsourcing-based image knowledge content generation method in accordance with an embodiment of the present invention will be described below with reference to FIGS. 1 to 4.

First, a data producer registers his/her own image provision unit 100, such as a CCTV, a vehicle black box, an unmanned camera of an intra-city bus, a police car camera, smartphone, etc., with the image crowdsourcing unit 300 in operation 100.

The image acquisition and processing unit 200 generates metadata of the image provision unit 100 itself and image data provided by the image provision unit 100 by a search of the registered image provision unit 100 and compose a profile of a producer in operation 420. The image acquisition and processing unit 200 pre-processes the image data and transmits the pre-processed image data to the image crowdsourcing unit 300 in operation 430.

Next, the image acquisition and processing unit 200 performs preprocessing, such as, annotation, translation, cropping, object identification, feature extraction, or image compression, on the image data to transmit the pre-processed image data to the image crowdsourcing unit in operation 430.

The image crowdsourcing unit models the image data and generates relevant image knowledge in operation 440. In this case, the image crowdsourcing unit provides an inquiry language and an inquiry engine for searching for and analyzing semantic 3-D image knowledge on the basis of the viewpoints (object/feature/event), receives the image data and metadata from the image acquisition and processing unit 200, pre-processes the image data through an image correction and image quality improvement filter, analyzes the metadata to generate annotation of the image data, tags the image data with the annotation and delivers the image data, receives the image data tagged with the annotation, detects and classifies moving objects in the image data using their features, tracks and labels the moving objects to extend the annotation, receives the image data tagged with the extensive annotation, and generate semantic 3-D image knowledge in operation 440.

Subsequently, the image crowdsourcing unit 300 receives a service request in operation 450, searches for and analyzes the image knowledge on the basis of the received request in operation 460, and requests a human intelligence task (HIT) through the crowdsourcing when the image knowledge stored and managed in the image crowdsourcing unit is not sufficient in operation 470. In this case, if the feature of the requested HIT is image data collection, the image data collection is automatically performed. If the feature of the requested HIT is image data analysis, the intervention of the producer is requested.

The image crowdsourcing unit 300 integrates HITs to generate a new knowledge content in operation 480, and provide the generated knowledge content to a user in operations 490.

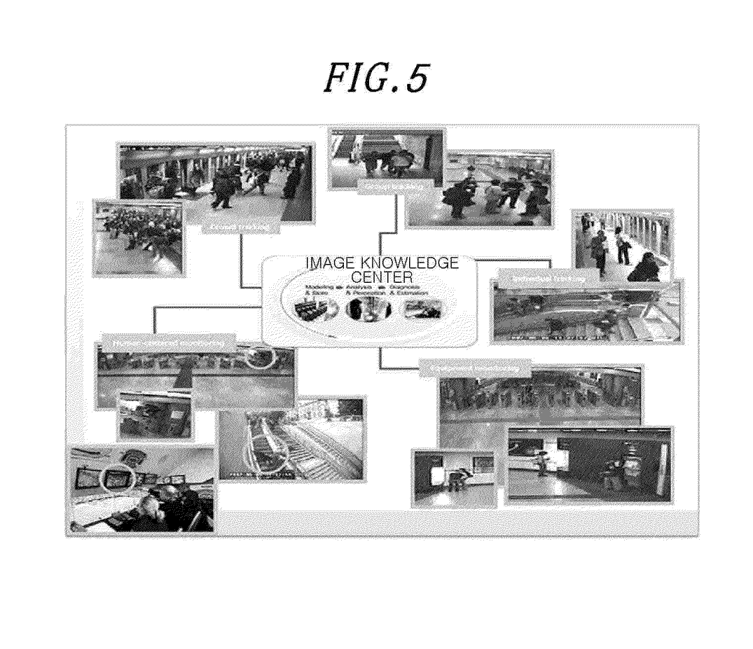

FIGS. 5 to 8 are exemplary diagrams of a crowdsourcing-based image knowledge content generation system and method in accordance with an embodiment of the present invention.

Referring to FIG. 5, an example of an image-based knowledge service performed by an image knowledge center, that is, the image crowdsourcing unit 300 of FIG. 1, is a public safety knowledge service for providing public safety by monitoring suspicious or dangerous persons in a public place, such as a subway station, airport, or stadium, where many persons are crowded together.

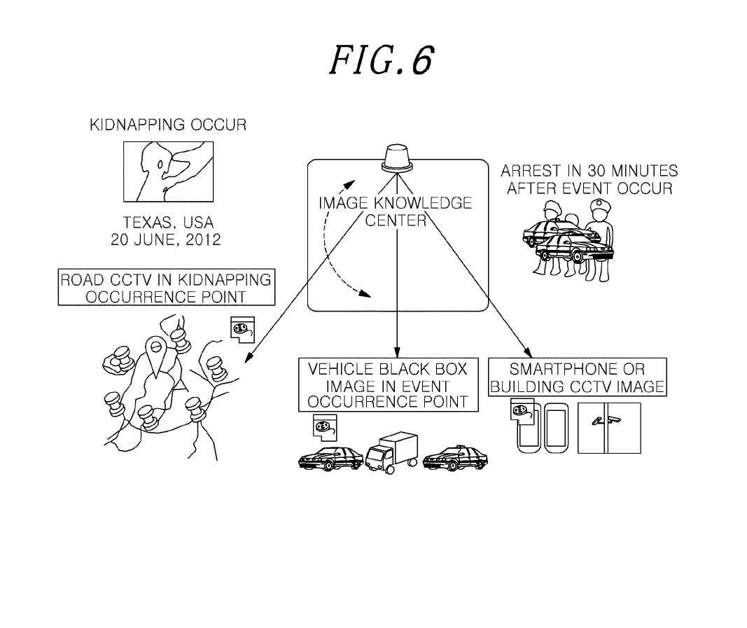

Referring to FIG. 6, another example of the image-based knowledge service is a public safety knowledge service for quickly arresting a criminal suspect by collecting image information through an image provision apparatus such as a CCTV, smartphone, or black box, which is positioned on an event occurrence point or escape path, when a crime such as child kidnapping occurs.

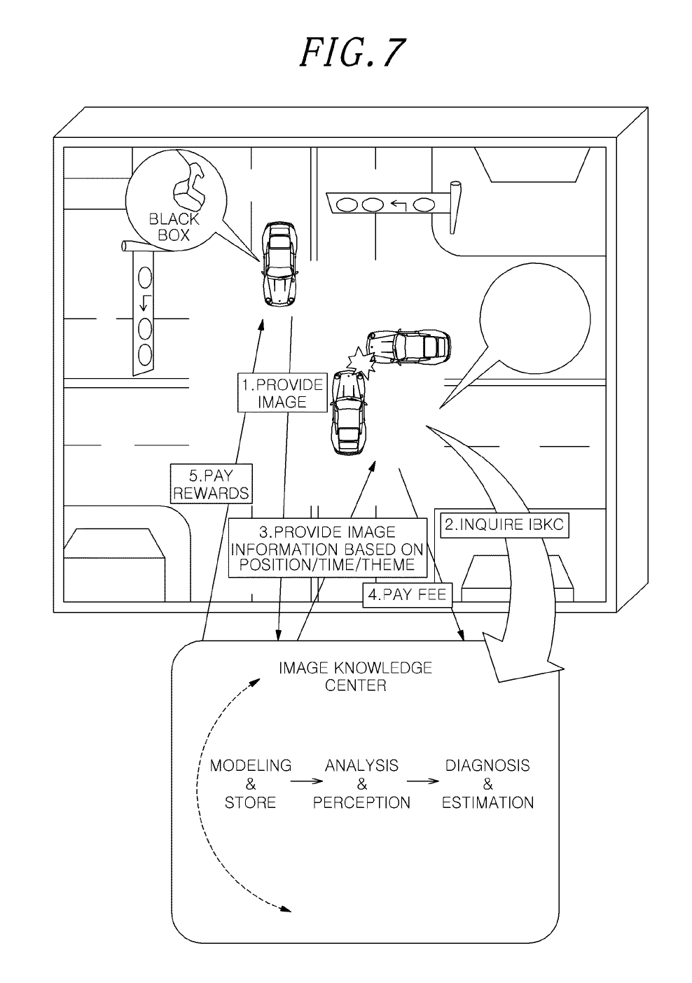

Referring to FIG. 7, another example of the image-based knowledge service is a public safety knowledge service for exactly determine negligence in a traffic accident by collecting image information through an image provision apparatus such as a CCTV around the traffic accident occurrence point or a black box of its surrounding vehicle.

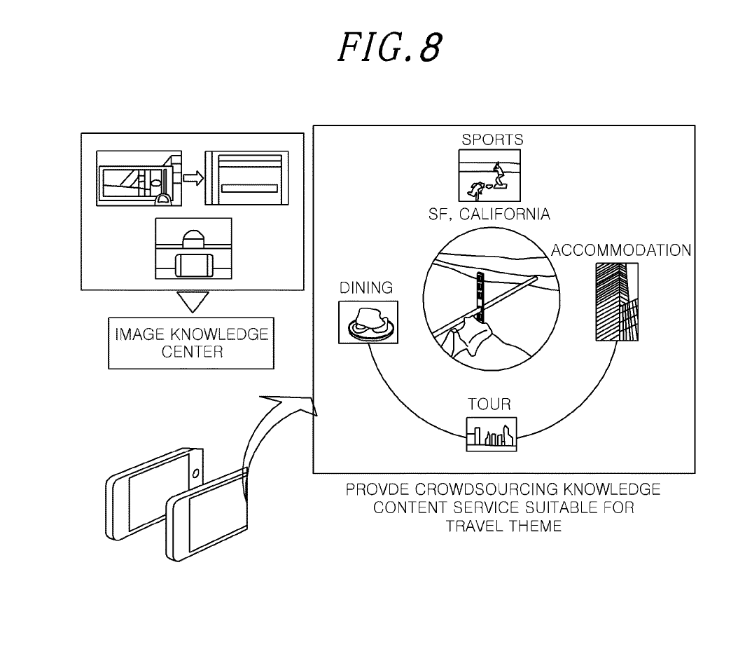

Referring to FIG. 8, another example of the image-based knowledge service is a personal knowledge service for providing travel information, such as a restaurant, a accommodation, entertainment, etc., which is associated with a tourist spot, when a traveler indicates the spot through a smartphone.

Combinations of respective blocks of the accompanying block diagram and combinations of respective steps of the accompanying flowchart may be performed by computer program instructions. Since these computer program instructions may be loaded onto a processor of a general purpose computer, special-purpose computer, or programmable data processing equipment, the instructions performed through the processor of the computer or programmable data processing equipment generate means for performing functions described in each block of the block diagram or each step of the flowchart. In addition, since these computer program instructions may be stored in a computer available or computer readable memory capable of directing a computer or programmable data processing equipment to implement a function in a specific manner, the instructions stored in the computer available or computer readable memory can produce a production list containing instruction means for performing a function described at each block of the block diagram or each step of the flowchart. Since these computer program instructions may be loaded onto a computer or programmable data processing equipment, the instructions for performing the computer or programmable data processing equipment by performing a series of operations on the computer or programmable data processing equipment to generate a computer-executable process can also provide steps for executing functions described in each block of the block diagram or each step of the flowchart.

In addition, each block or step may indicate a portion of a module, segment, or code including one or more executable instructions for executing a specific logical function(s). It should be also noted that, in several alternative embodiments, functions referred to in blocks or steps may be performed irrespective of the order. For example, two blocks or steps shown sequentially may be performed at the same time or in a reverse order if necessary.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A system for generating crowdsourcing-based image knowledge content, the system comprising:
an image provision unit configured to provide image data;
an image crowdsourcing unit configured to generate, store, or manage image knowledge in order to provide an image-base knowledge service; and
an image acquisition and processing unit configured to connect the image provision unit and the image crowdsourcing unit and actively or automatically provide a crowdsourcing technique.

2. The system of claim 1, wherein the image acquisition and processing unit comprises:
a human intelligence task (HIT) processing unit configured to process an HIT requested by the image crowdsourcing unit; and
an image data preprocessing unit configured to search for the image data provided from the image provision unit to perform indexing, annotation, translation, cropping, object identification, feature extraction, or image compression on the image data.

3. The system of claim 1, wherein the image acquisition and processing unit further comprises:
a producer profile database (DB) configured to store a profile of a producer of the image data; and
a metadata database (DB) configured to store metadata of the image data.

4. The system of claim 2, wherein,
if a feature of the HIT requested by the image crowdsourcing unit is image data collection, the image data collection is automatically performed using the profile of the producer, and
if the feature of the requested HIT is image data analysis, the intervention of the producer is requested.

5. The system of claim 1, wherein the image crowd sourcing unit comprises:
an image-based knowledge generation unit configured to generate knowledge from the image data; and
a real-time complex event management unit configured to monitor a meaningful complex event among a large amount of single events in real time to provide necessary information to an event listener interested in the event.

6. The system of claim 5, wherein the image crowdsourcing unit further comprises:
an image knowledge DB configured to store or manages semantic 3-D image knowledge;
an image knowledge ontology DB configured to provide an ontology for generating the semantic 3-D image knowledge;
a semantic annotation generation unit configured to generate image information on the basis of the ontology provided from the image knowledge ontology DB;
a moving object DBMS configured to store and manage a moving object generated by the image-based knowledge generation unit; and
a multi-viewpoint image information DB configured to store and manage multi-viewpoint image information generated by the image-based knowledge generation unit.

7. The system of claim 6, wherein the image-based knowledge generation unit comprises:
an image knowledge analysis and inquiry processing unit configured to provide an inquiry language and an inquiry engine for searching for and analyzing the semantic 3-D image knowledge on the basis of the viewpoints (object/feature/event) from the image knowledge DB;
an image data processing unit configured to receive the image data and metadata from the image acquisition and processing unit, pre-process the image data through an image correction and image quality improvement filter, analyze the metadata to generate annotation of the image data, tag the image data with the annotation, and deliver the tagged image data;
an image information processing unit configured to receive the image data tagged with the annotation from the image data processing unit, detect and classify objects using features of moving objects in the image data, and track and label the moving objects to extend the annotation; and
an image knowledge processing unit configured to receive the image data tagged with the extensive annotation from the image information processing unit and generate the semantic 3-D image knowledge on the basis of the image information and the image knowledge ontology DB through the semantic annotation generation unit.

8. The system of claim 7, wherein the image crowdsourcing unit further comprises a time space situation information management unit configured to provide an individual inquiry through the inquiry language provided by the image knowledge analysis and inquiry processing unit and when a complex situation is described and previously registered, monitor a situation, perceive the registered situation through inference, and provide necessary knowledge to a user.

9. A method of generating crowdsourcing-based image knowledge content executed in an image knowledge content generation system including an image provision unit, an image acquisition and processing unit, and an image crowdsourcing unit, the method comprising:
registering the image provision unit with the image crowdsourcing unit;
generating, by the image acquisition and processing unit, metadata of the image provision unit itself and image data provided by the image provision unit through search of the registered image provision unit and composing a profile of a producer;
preprocessing the image data to transmit the preprocessed image data to the image crowdsourcing unit; and
modeling, by the image crowdsourcing unit, the image data and generating relevant image knowledge.

10. The method of claim 9, further comprising:
receiving, by the image crowdsourcing unit, a service request;
searching for and analyzing the image knowledge on the basis of the service request received from the image crowdsourcing unit; and
requesting a human intelligence task (HIT) through crowdsourcing when the image knowledge stored and managed in the image crowdsourcing unit is not sufficient.

11. The method of claim 10, further comprising:
integrating, by image crowdsourcing unit, the HIT to generate a new knowledge content; and
providing the generated knowledge content to a user.

12. The method of claim 9, wherein the preprocessing of the image data comprises performing annotation, translation, cropping, object identification, feature extraction, or image compression on the image data.

13. The method of claim 10, wherein,
if a feature of the requested HIT is image data collection, the image data collection is automatically performed using the profile of the producer, and
if the feature of the requested HIT is image data analysis, the intervention of the producer is requested.

14. The method of claim 10, further comprising:
storing or managing semantic 3-D image knowledge;
providing an ontology for generating the semantic 3-D image knowledge;
generating image information on the basis of the ontology;
storing and managing a moving object generated by the image-based knowledge generation unit; and
storing and managing multi-viewpoint image information generated by the image-based knowledge generation unit.

15. The method of claim 14, wherein the generating of knowledge from the image data comprises:
providing an inquiry language and an inquiry engine for searching for and analyzing the semantic 3-D image knowledge on the basis of multi-viewpoints (object/feature/event);
receiving the image data and metadata from the image acquisition and processing unit, pre-processing the image data through an image correction and image quality improvement filter, analyzing the metadata to generate annotation of the image data, tagging the image data with the annotation, and delivering the tagged image data;
receiving the image data tagged with the annotation, detecting and classifying objects through features of moving objects in the moving object, and tracking and labeling the moving object to extend the annotation; and
receiving the image data tagged with the extensive annotation and generating the semantic 3-D image knowledge.
